(19) United States
(12) Patent Application Publication
(10) Pub. No.: US 2026/0023821 A1
(43) Pub. Date: Jan. 22, 2026

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Akihiro YAMAGUCHI, Kita (JP); Ryusei SHINGAKI, Setagaya (JP)

(73) Assignee: KABUSHIKI KAISHA TOSHIBA, Tokyo (JP)

(21) Appl. No.: 19/255,137

(22) Filed: Jun. 30, 2025

(30) Foreign Application Priority Data
Jul. 17, 2024 (JP) 2024-113756

(51) Int. Cl. G06F 18/2415; G06F 123/02

(52) U.S. Cl. CPC G06F 18/2415; G06F 2123/02

(57) ABSTRACT

According to an embodiment, an information processing apparatus includes one or more hardware processors configured to: obtain a first feature including a feature indicating a temporal order and a second feature different from the first feature of input time-series data by using an encoder that extracts the first feature and the second feature from the input time-series data; obtain output time-series data generated based on the first feature and the second feature obtained from the input time-series data by using a decoder that generates the output time-series data based on the first feature and the second feature that are input; and train the encoder and the decoder such that a difference between the input time-series data and the output time-series data becomes small.

### CROSS-REFERENCE TO RELATED APPLICATIONS

This application is based upon and claims the benefit of priority from Japanese Patent Application No. 2024-113756, filed on Jul. 17, 2024; the entire contents of which are incorporated herein by reference.

### FIELD

Embodiments described herein relate generally to an information processing apparatus, an information processing method, and a computer program product.

### BACKGROUND

There is an increasing need for a time-series waveform analysis technique for determining time-series data by a machine learning model (determination model). In such a technique, in addition to the determination performance, there is a case where an explanatory property for clearly presenting a determination basis is required. Therefore, a technique of giving a determination basis by focusing on observed time-series data has been studied.

As one of techniques for presenting a determination basis, a technique called anti-fact explanation has been proposed. The anti-fact explanation is to generate and present time-series data (anti-fact waveform) obtained by changing the time-series data used for the determination so as to obtain data that can obtain a desired result different from the determination result by the determination model.

### BRIEF DESCRIPTION OF THE DRAWINGS

FIG. 1 is a diagram illustrating an example of generating an anti-fact waveform;

FIG. 2 is a diagram illustrating an example of generating an anti-fact waveform;

FIG. 3 is a block diagram of an information processing apparatus according to an embodiment;

FIG. 4 is a diagram illustrating a configuration example of a self-encoding unit using VAE;

FIG. 5 is a diagram illustrating a configuration example of a self-encoding unit using a conditional VAE;

FIG. 6 is a flowchart of a learning process according to the embodiment;

FIG. 7 is a flowchart of a generating process according to the embodiment; and

FIG. 8 is a hardware configuration diagram of the information processing apparatus according to the embodiment.

### DETAILED DESCRIPTION

According to an embodiment, an information processing apparatus includes one or more hardware processors configured to: obtain a first feature including a feature indicating a temporal order and a second feature different from the first feature of input time-series data by using an encoder that extracts the first feature and the second feature from the input time-series data; obtain output time-series data generated based on the first feature and the second feature obtained from the input time-series data by using a decoder that generates the output time-series data based on the first feature and the second feature that are input; and train the encoder and the decoder such that a difference between the input time-series data and the output time-series data becomes small.

Hereinafter, a preferred embodiment of an information processing apparatus according to the present invention will be described in detail with reference to the accompanying drawings.

In the known technique related to an anti-fact explanation, there is a case where data (anti-fact waveform) representing the anti-fact explanation for the time-series data cannot be generated with high accuracy. For example, the known technique has the following problems.
(PA) Many known techniques are based on the premise that a neural network capable of differentiation is used as a determination model. The technique based on the determination model capable of differentiation cannot be applied to a time-series waveform analysis technique in which many determination models incapable of differentiation are used.
(PB) Since the locality of the waveform indicated by the anti-fact waveform and the original time-series data is not considered, the entire time-series data may be changed. That is, it is not possible to generate an anti-fact explanation in which the time-series data is locally changed.
(PC) The time-series data may include, for example, a region with large variation and a region with small variation even in a waveform indicating normal. In a region where the variation is small, a slight difference in the waveform may affect the determination. Therefore, it is desirable to consider the magnitude of the variation even in the case of generating the anti-fact waveform. However, in the known technique, the magnitude of waveform variation is not considered.

In order to solve at least a part of the above problems, the present embodiment has the following functions, for example.
(F1) Function of extracting a feature having a dimension lower than a dimension of time-series data in consideration of a structure of the time-series data
(F2) Function of calculating an importance degree of each time (each point) of the time-series data when learning a latent space
(F3) Function of selecting a change area of the time-series data for generating the anti-fact waveform in the latent space in consideration of a structure of the time-series data

The feature extracted from the time-series data is represented by, for example, a vector. A feature represented by a vector may be referred to as a feature vector. Note that the latent space is information obtained from the extracted features, and can be represented by a vector similarly to the feature vector. The latent space can also be interpreted as information (feature vector) indicating a feature of the time-series data.

The low-dimensional feature in consideration of the structure of the time-series data is, for example, a feature vector that maintains an order relationship of time of the time-series data, in other words, a feature vector FA (first feature) including a feature indicating a temporal order. A feature vector FB (second feature) different from the feature vector FA including the feature indicating the temporal order is further extracted from the time-series data.

In the present embodiment, a latent space is learned based on a feature (feature vector) that maintains an order relationship of time of time-series data, and generates an anti-fact waveform in which the time-series data is locally changed by using the order relationship of time maintained in the latent space.

Hereinafter, the time-series waveform analysis method of the present embodiment will be described. The time-series waveform analysis method of the present embodiment can be divided into two phases of a learning phase and a generation phase.

The learning phase executed first is a phase of learning the latent space of the time-series data set using a plurality of time-series data (time-series data set). Learning the latent space corresponds to, for example, training a model (encoder, decoder) that obtains the latent space from the input time-series data (input time-series data) and restores the input time-series data from the obtained latent space. This model is a model used to generate the anti-fact waveform, and is a model different from the determination model used to determine the time-series data. The learning of the latent space may be executed independently of the training of the determination model, or may be executed together with the determination model.

The generation phase is a phase of generating an anti-fact waveform for the target time-series data (test time-series data) to be determined using the latent space (model) learned in the learning phase. The target time-series data is, for example, time-series data observed as a determination target by the determination model.

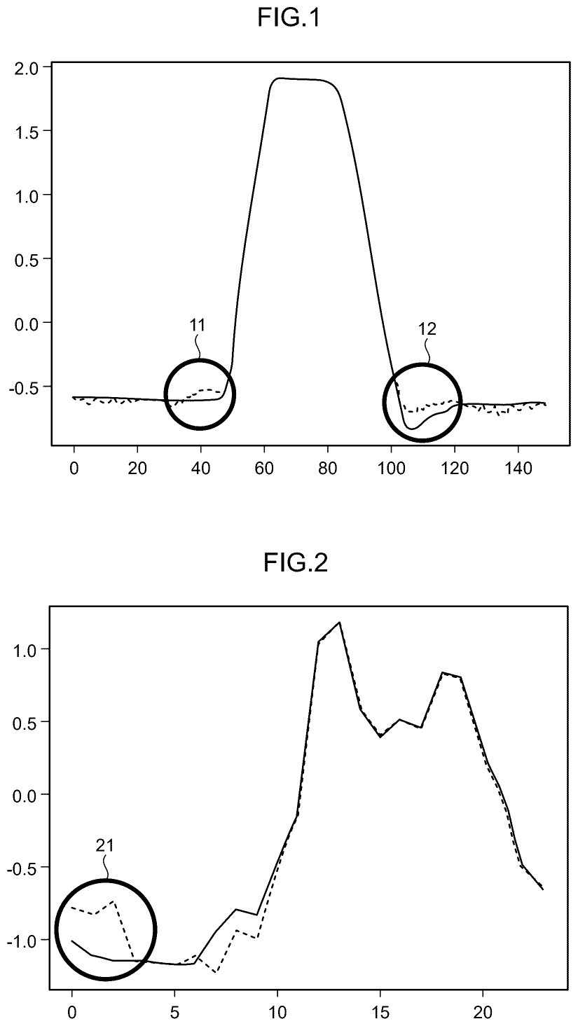

In the present embodiment, when a trained determination model is given in advance, it is usable to generate an anti-fact waveform corresponding to an anti-fact explanation for the target time-series data. Here, an example of generating the anti-fact waveform will be described. FIGS. 1 and 2 are diagrams illustrating an example of generating an anti-fact waveform.

FIG. 1 is an application example to an analysis technique for a time-series data set of a motion waveform including two classes of a case where a real gun is shot and a case where a finger is pointed without a gun. For example, a waveform of a solid line corresponds to a waveform observed when a finger is pointed. The waveform of the broken line corresponds to an anti-fact waveform obtained by changing the observed waveform to indicate a case where the real gun is shot.

In the application example as illustrated in FIG. 1, it is known that a protrusion appears when the gun is removed from the holster in a case where the real gun is shot, and an overshoot occurs when the arm is lowered in a case where the finger is pointed. In FIG. 1, as expected, the anti-fact waveform is generated so as to suppress an overshoot 12 that is the characteristic in the case of pointing the finger while generating a protrusion 11 that is the feature in the case of shooting the real gun.

FIG. 2 is an application example to an analysis technique targeting a time-series data set representing a daily transition of the number of pedestrians in a downtown including two classes of a class indicating a weekday and a class indicating a holiday. For example, the waveform of the solid line corresponds to a waveform observed as time-series data representing the transition of the number of pedestrians on weekdays. The waveform of the broken line corresponds to an anti-fact waveform obtained by changing the observed waveform to indicate a holiday.

In the application example as illustrated in FIG. 2, it is known that the number of pedestrians at midnight increases in the case of a holiday as compared with a weekday. In FIG. 2, as expected, an anti-fact waveform including an area 21 where the number of pedestrians increases at midnight is generated.

When generating the anti-fact waveform, the class of the observed original time-series data (target time-series data) may be unknown, and the class can be predicted using a trained determination model. The designated class (desired class) designated by the user as the class of interest is a class different from the target time-series data. For example, in a case where there are two classes of normality and abnormality, when it is detected (determined) that the target time-series data is abnormal, a class indicating the normality is designated as the designated class. When there are two or more abnormal classes and it is detected that the target time-series data is a certain abnormality (hereinafter, abnormality AA), a class indicating an abnormality different from the abnormality AA may be designated as the designated class.

In the case of abnormality detection (waveform abnormality detection) for time-series data, the determination model is an abnormality detection model that inputs time-series data and determines which of a plurality of classes the input time-series data belongs to, the class including a normal class indicating that the time-series data is normal and an abnormal class indicating that the time-series data is abnormal. The input time-series data used when training the abnormality detection model may be time-series data that can be regarded as belonging to a normal class. The determination model of abnormality detection can also be interpreted as an abnormality detection model that outputs an abnormality score or a normality score representing the degree of abnormality or normality of the time-series data.

The abnormality detection model may be configured in any manner. For example, the abnormality detection model may be configured to include a generation model that generates a waveform feature vector of input time-series data and a determination model that determines to which of a plurality of classes the time-series data belongs using the waveform feature vector. The generation model can be realized by, for example, MiniRocket, catch 22, or the like. The determination model using the waveform feature vector can be realized by, for example, local outlier factor (LOF), isolation forest, and the like.

In the case of class classification (time-series classification) for time-series data, the determination model can also be interpreted as a model that inputs time-series data and outputs a prediction probability of each class.

Next, a reason for handling the latent space instead of the time-series data itself will be described. When assuming that the time-series data has a length of T points (T is an integer of 2 or more), it is not considered that the time-series data can take any value on the T-dimensional vector space, but considered that the time-series data is distributed on a lower dimensional (m dimension, m is an integer smaller than T) latent space.

Based on such an idea, in a case where an m-dimensional vector on the latent space is changed so as not to deviate from the distribution on the latent space, it can be expected that the waveform that can be actually observed is maintained even if the waveform is changed in the time-series data in which the length corresponding to the changed m-dimensional vector is the T points. Therefore, instead of changing the time-series data itself, the anti-fact waveform is generated so as not to greatly deviate from the original time-series data in the latent space. Another reason is that the latent space is low dimensional, so that the search of the anti-fact waveform can be performed more efficiently than the search of the time-series data having a length of the T points.

A configuration example of an information processing apparatus capable of executing the learning phase and the generation phase will be described. As will be described later, the information processing apparatus may be configured to execute either the learning phase or the generation phase.

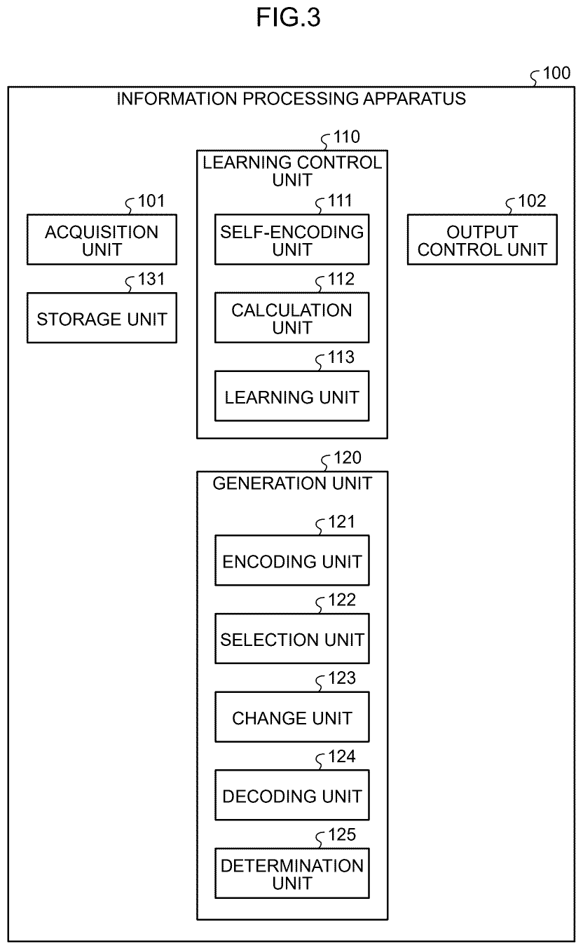

FIG. 3 is a block diagram illustrating an example of a configuration of an information processing apparatus 100 according to the embodiment. As illustrated in FIG. 3, the information processing apparatus 100 includes a storage unit 131, an acquisition unit 101, a learning control unit 110, a generation unit 120, and an output control unit 102.

The storage unit 131 stores various types of information used in the information processing apparatus 100. For example, the storage unit 131 stores input time-series data (input time-series data, target time-series data), output time-series data (output time-series data), parameters of each model, and the like.

Note that the storage unit 131 can be configured by any commonly used storage medium such as a flash memory, a memory card, a random access memory (RAM), a hard disk drive (HDD), and an optical disc.

The acquisition unit 101 acquires various types of information used in the information processing apparatus 100. For example, the acquisition unit 101 acquires input time-series data (input time-series data, target time-series data) and information of the determination model.

In the learning phase, the acquisition unit 101 acquires a plurality of pieces of input time-series data (time-series data set) used for learning. In the case of abnormality detection, the time-series data set may be a normal time-series data set not including abnormal data or a time-series data set including only a small number of abnormal data. In the case of time-series classification, the time-series data set may be a time-series data set of all classes, or may be a time-series data set including a designated class.

In the learning phase, acquisition of information of the determination model is not essential. In a case where the importance degree of the time-series data at each time is considered, the acquisition unit 101 may acquire the information of the determination model in the learning phase.

A method for acquiring information by the acquisition unit 101 may be any method, and for example, a method for receiving information from an external device via a network, a method for reading information from a storage medium, or the like can be applied.

The learning control unit 110 controls a process of the learning phase. The learning control unit 110 includes a self-encoding unit 111, a calculation unit 112, and a learning unit 113.

The self-encoding unit 111 performs self-encoding on the input time-series data to obtain output time-series data corresponding to the input time-series data. For example, the self-encoding unit 111 includes an encoder and a decoder.

The encoder is a function of encoding input time-series data and outputting a feature vector. For example, the encoder extracts and outputs a feature vector FA including a feature indicating a temporal order and a feature vector FB different from the feature vector FA from the input time-series data.

The decoder is a function of inputting a feature vector output from the encoder, generating and outputting output time-series data. For example, the decoder inputs the feature vector FA and the feature vector FB, generates output time-series data on the basis of the input feature vector FA and the input feature vector FB, and outputs the output time-series data.

For example, the self-encoding unit 111 obtains a feature vector FA and a feature vector FB using an encoder. The self-encoding unit 111 inputs the obtained feature vector FA and feature vector FB to a decoder, and obtains output time-series data output by the decoder.

The calculation unit 112 calculates the importance degrees of the input time-series data at a plurality of times. The importance degrees are referred to when the learning unit 113 learns the latent variable (self-encoding unit 111). Note that, in a case where the importance degrees are not used at the time of learning, the calculation unit 112 may not be provided.

For example, the calculation unit 112 inputs the input time-series data to the determination model that determines the class to which the time-series data belongs, and calculates the importance degrees indicating the degrees of change in the determination result of the determination model at a plurality of times of the input time-series data that has been input. The importance degree can also be interpreted as the sensitivity of the determination model to the input time-series data at each time.

In a case where the determination model is a non-differentiable model, the calculation unit 112 calculates, for example, a change amount of the output of the determination model in a case where the value at each time is slightly changed in the input time-series data as the importance degree. The change amount may be a statistical value (average, median, or the like) for a plurality of pieces of input time-series data. In a case where the determination model is a differentiable model, the calculation unit 112 calculates, for example, an absolute value of differentiation of the input time-series data at each time as the importance degree.

The learning unit 113 performs training of the self-encoding unit 111. For example, the learning unit 113 trains the encoder and the decoder included in the self-encoding unit 111 such that a difference between the input time-series data and the output time-series data output by the self-encoding unit 111 becomes small. In a case where the importance degrees are calculated, the learning unit 113 trains the encoder and the decoder such that the difference obtained by weighting the values of the time-series data at a plurality of times with the importance degrees becomes small.

The encoder and the decoder obtained by training are used in the generation phase. Information (such as parameters) indicating the trained encoder and decoder is stored in, for example, the storage unit 131.

The generation unit 120 executes processing of the generation phase. The generation unit 120 includes an encoding unit 121, a selection unit 122, a change unit 123, a decoding unit 124, and a determination unit 125.

The encoding unit 121 obtains the feature vector FA and the feature vector FB by encoding the target time-series data. For example, the encoding unit 121 obtains the feature vector FA and the feature vector FB output by the encoder by inputting the target time-series data to the trained encoder. The information of the trained encoder can be obtained from, for example, the storage unit 131.

The selection unit 122 corresponds to a function of selecting a change area in the latent space for generating the anti-fact waveform. For example, the selection unit 122 selects one or more partial features including elements having a consecutive temporal order from the feature vector FA as the change area.

The number K of the partial features to be selected and the maximum length representing the maximum value of the lengths of the partial features to be selected may be acquired by the acquisition unit 101. In this case, the selection unit 122 may select, from the feature vector FA, a partial feature with a number K and a length shorter than the maximum length. For example, the selection unit 122 selects the K number of partial features having different start positions while changing the length without exceeding the maximum length.

As described above, the feature vector FA is a feature vector that maintains an order relationship of time of the input time-series data. For example, two adjacent elements among a plurality of elements included in the feature vector FA are elements closer to each other in temporal order than the other elements. Therefore, the selection unit 122 can select partial features including elements having a consecutive temporal order by selecting partial features including two or more adjacent elements.

The change unit 123 generates a changed feature vector (changed feature) changed from the feature vector FA by changing the value of the partial feature selected by the selection unit 122.

The decoding unit 124 obtains output time-series data output by the decoder by inputting the changed feature vector and the feature vector FB to the decoder.

The determination unit 125 inputs the obtained output time-series data to the determination model, and repeatedly executes a searching process of obtaining the output class output by the determination model until the output class becomes the designated class.

The generation unit 120 outputs the output time-series data when the output class becomes the designated class as the anti-fact waveform. Details of the generation phase by the generation unit 120 will be described later.

The output control unit 102 controls output of various types of information used in the information processing apparatus 100. For example, the output control unit 102 outputs the anti-fact waveform generated by the generation unit 120. The information output method may be any method, and for example, a method for displaying on a display device, a method for transmitting information to an external device via a network, and the like can be applied.

At least a part of each unit (acquisition unit 101, learning control unit 110, generation unit 120, and output control unit 102) may be realized by one or more processing units. Each of the above units is realized by, for example, one or more processors. For example, each of the above units may be realized by causing a processor such as a central processing unit (CPU) and a graphics processing unit (GPU) to execute a program, that is, by software. Each of the above units may be realized by a processor such as a dedicated integrated circuit (IC), that is, hardware. Each of the above units may be realized by using software and hardware in combination. When a plurality of processors are used, each processor may realize one of the units or two or more of the units.

The information processing apparatus 100 may be physically configured by one device or may be physically configured by a plurality of devices. For example, the information processing apparatus 100 may be constructed on a cloud environment. Furthermore, each unit in the information processing apparatus 100 may be dispersedly provided in a plurality of devices. For example, the information processing apparatus 100 (information processing system) may be configured to include a device (for example, a learning device) including a function (such as the learning control unit 110) necessary for execution of the learning phase and a device (for example, a generation device) including a function (such as a generation unit 120) necessary for execution of the generation phase.

The information processing apparatus 100 may be realized as a device (for example, a learning device) including only functions (such as the learning control unit 110) necessary for execution of the learning phase. Similarly, the information processing apparatus 100 may be realized as a device (for example, a generation device) including only functions (such as the generation unit 120) necessary for execution of the generation phase.

Next, an example of a detailed configuration of the self-encoding unit 111 will be described. Hereinafter, an example of configuring the self-encoding unit 111 to use a variational auto encoder (VAE) for learning of a latent space will be described. In the present embodiment, the VAE is configured to learn the feature vector FA maintaining the order relationship of the time-series data separately from the other feature vectors FB. Hereinafter, the feature vector FA that maintains the order relationship of the time-series data may be referred to as an order-maintaining latent variable.

The applicable model is not limited to VAE. For example, another model that can distinguish and extract the feature vector FA and the feature vector FB from the input time-series data and obtain the output time-series data corresponding to the input time-series data using the feature vector FA and the feature vector FB may be used.

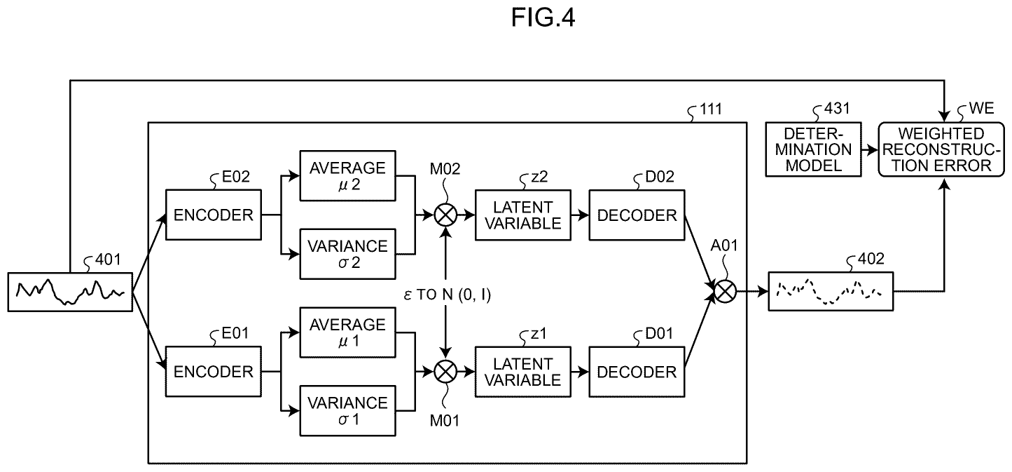

FIG. 4 is a diagram illustrating a configuration example of the self-encoding unit 111 using VAE. As illustrated in FIG. 4, the self-encoding unit 111 includes encoders E01 and E02, multipliers M01 and M02, decoders D01 and D02, and an adder A01. The self-encoding unit 111 inputs input time-series data 401 and outputs output time-series data 402.

In the configuration of FIG. 4, a function including the encoders E01 and E02 and the multipliers M01 and M02 corresponds to the encoder, and a function including the decoders D01 and D02 and the adder A01 corresponds to the decoder. For example, a latent variable z1 (first latent variable) which is an output of the multiplier M01 corresponds to the feature vector FA, and a latent variable z2 (second latent variable) which is an output of the multiplier M02 corresponds to the feature vector FB. The latent variable z1 corresponds to an order-maintaining latent variable. Averages μ1 and μ2 and variances σ1 and σ2, which are the outputs of the encoders E01 and E02, can also be interpreted as feature vectors representing the features of the input time-series data 401, but are distinguished from the feature vector FA and the feature vector FB, which are information used when the decoders D01 and D02 generate the output time-series data 402. Here, the multiplier may calculate the latent variable z1 as μ1+ε×sqrt (σ1) and may calculate the latent variable z2 as μ2+ε×sqrt (σ2) when the noise ε is given. In addition, sqrt means calculation of a square root.

The encoder E01 encodes the input time-series data 401, and outputs the average μ1 and the variance σ1 as a feature vector. The encoder E02 encodes the input time-series data 401, and outputs the average μ2 and the variance σ2 as a feature vector.

The encoder E01 is realized by, for example, a neural network model NE1 (first neural network model) that inputs the input time-series data 401 and outputs a feature vector (first vector) having the dimension number smaller than the dimension number of the input time-series data 401 and including a feature indicating the temporal order of the input time-series data 401.

The neural network model NE1 is configured to include, for example, one or more convolution layers and one or more local pooling layers. The configuration of the neural network model NE is not limited thereto, and the neural network model may have any configuration as long as a feature vector including a feature indicating the temporal order of the input time-series data 401 can be obtained. For example, a neural network model including a fully connected layer in which weights are regularized so that the temporal order is maintained may be used.

The encoder E02 is realized by, for example, a neural network model NE2 (second neural network model) that inputs the input time-series data 401 and outputs a feature vector (second vector) having the dimension number smaller than the dimension number of the input time-series data 401.

The neural network model NE2 is configured to include, for example, one or more fully connected layers. The configuration of the neural network model NE2 is not limited thereto, and the neural network model may have any configuration as long as a feature vector including a feature different from a feature indicating the temporal order can be obtained. For example, a neural network model including a convolution layer and a global pooling layer may be used.

The encoder E02 may be configured to obtain the feature vector of the input time-series data 401 by a method other than the neural network model. For example, the encoder E02 may output the feature vector FA (latent variable z2) by frequency analysis on the input time-series data 401. The frequency analysis may be, for example, analysis using Fast Fourier transformation (FFT).

The multiplier M01 outputs the latent variable z1 (feature vector FA) by multiplying the feature vector (average μ1, variance σ1) by the noise ε. The latent variable z1 corresponds to a latent variable based on the feature vector output by the encoder E01. The multiplier M02 outputs the latent variable z2 (feature vector FB) by multiplying the feature vector (average μ2, variance σ2) by the noise ε. The latent variable z2 corresponds to a latent variable based on the feature vector output by the encoder E02.

The noise ε is generated, for example, according to a standard normal distribution N (0, I). The noise used by the multiplier M01 and the noise used by the multiplier M02 may have different values or the same value.

As described above, the latent variable z1 (order-maintaining latent variable) that maintains the order relationship and the latent variable z2 that does not maintain the order relationship are obtained by the function of the encoder including the encoders E01 and E02 and the multipliers M01 and M02. A dimension of each latent variable is an m dimension.

Next, the decoder (decoders D01 and D02, adder A01) will be described. The decoder D01 inputs the latent variable z1 (order-maintaining latent variable) and outputs a T-dimensional vector V1 (time-series data) having the same size as the input time-series data 401.

The decoder D01 is realized by, for example, the neural network model ND1 that inputs the latent variable z1 and outputs the T-dimensional vector V1 having the same dimension number as the input time-series data 401. The neural network model ND1 has a configuration corresponding to the neural network model NE1 used by the encoder E01. For example, when the neural network model NE1 has a configuration in which a convolution layer and a local pooling layer are stacked, the neural network model ND1 can have a configuration in which a convolution layer and an upscaling layer are stacked.

The decoder D02 inputs the latent variable z2 and outputs a T-dimensional vector V2 (time-series data) having the same size as the input time-series data 401.

The decoder D02 is realized by, for example, the neural network model ND2 that inputs the latent variable z2 and outputs the T-dimensional vector V2 having the same dimension number as the input time-series data 401. The neural network model ND2 has a configuration corresponding to the neural network model NE2 used by the encoder E02. For example, when the neural network model NE2 has a configuration in which fully connected layers are stacked, the neural network model ND2 can also have a configuration in which fully connected layers are stacked.

The adder A01 executes an aggregation operation such as addition and averaging on the T-dimensional vector V1 output from the decoder D01 and the T-dimensional vector V2 output from the decoder D02, and outputs output time-series data 402 that is a T-dimensional vector having the same dimension number as the input time-series data 401.

Similarly to the normal VAE, the learning unit 113 learns the encoder and the decoder together such that the feature vectors corresponding to the average and the variance obtained by the encoders (encoders E01 and E02) approach the prior distribution and the difference (error) between the decoded output time-series data 402 and the input time-series data 401 decreases.

In a case where the importance degrees are calculated, the learning unit 113 may weight each time of the time-series data by using the importance degree calculated from a determination model 431, and then execute learning so that a difference (weighted reconstruction error WE) between the output time-series data 402 and the input time-series data 401 decreases. By using the importance degrees, for example, it is possible to consider the magnitude of variation in different regions of waveforms in the same class.

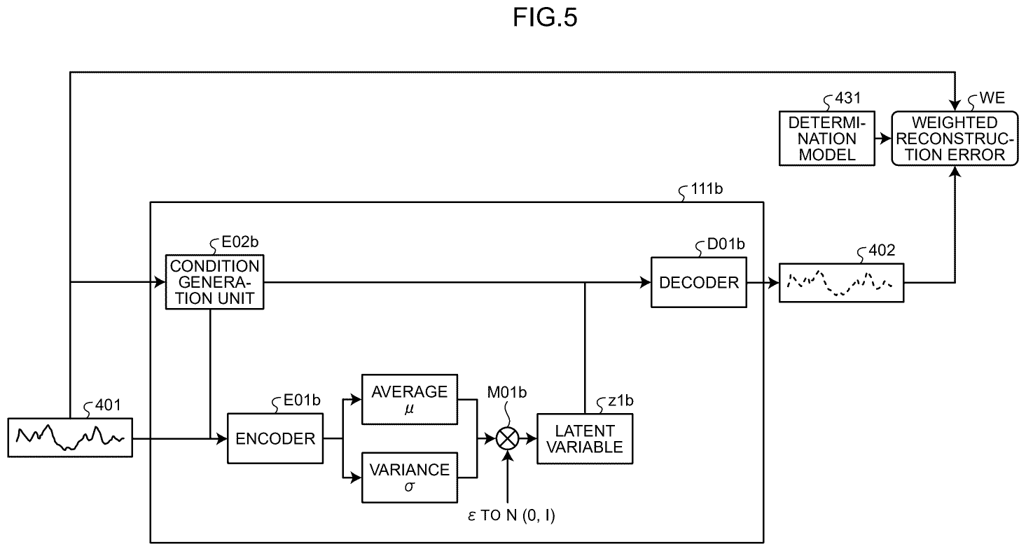

FIG. 5 is a diagram illustrating a configuration example of a self-encoding unit 111b different from that in FIG. 4. FIG. 5 illustrates an example in which the self-encoding unit 111b is realized in a framework of conditional VAE (Conditional Variational Auto Encoder: CVAE). As illustrated in FIG. 5, the self-encoding unit 111b includes an encoder E01b, a condition generation unit E02b, a multiplier M01b, and a decoder D01b.

In the configuration of FIG. 5, a function including the encoder E01b, the condition generation unit E02b, and the multiplier M01b corresponds to the above-described encoder, and the decoder D01b corresponds to the above-described decoder. For example, the latent variable z1 which is the output of the multiplier M01b corresponds to the feature vector FA, and the output of the condition generation unit E02b corresponds to the feature vector FB.

The condition generation unit E02b encodes the input time-series data 401 and outputs the feature vector FB. The feature vector FB is a feature vector corresponding to a condition given to the VAE, and may not be in a format including the average μ2 and the variance σ2 as in the encoder E02 in FIG. 4.

The condition generation unit E02b is realized by, for example, a neural network model NE2b (second neural network model) that inputs the input time-series data 401 and outputs a feature vector FB (second vector) having the dimension number smaller than the dimension number of the input time-series data 401.

The configuration of the neural network model NE2b can be similar to that of the neural network model NE2. The condition generation unit E02b may be configured to obtain the feature vector FB of the input time-series data 401 by a method other than the neural network model. For example, the condition generation unit E02b may output the feature vector FB by frequency analysis on the input time-series data 401.

The encoder E01b is different from the encoder E01 in FIG. 4 in further inputting the feature vector FB output from the condition generation unit E02b. That is, the encoder E01b inputs the input time-series data 401 and the feature vector FB, and outputs the feature vector (average μ and variance σ) conditioned by the feature vector FB.

The encoder E01b is realized by, for example, a neural network model NE1b (first neural network model) that inputs the input time-series data 401 and the feature vector FB and outputs a feature vector (first vector) having the dimension number smaller than the dimension number of the input time-series data 401 and including a feature indicating the temporal order of the input time-series data 401. The configuration of the neural network model NE1b can be similar to that of the neural network model NE1.

The multiplier M01b outputs the latent variable z1b (feature vector FA) by multiplying the feature vector (average μ, variance σ) by the noise ε. The latent variable z1b corresponds to a latent variable based on the feature vector output by the encoder E01b.

In the example of FIG. 5, by the function of the encoder including the encoder E01b, the condition generation unit E02b, and the multiplier M01b, the feature vector FA that is the latent variable z1b (order-maintaining latent variable) maintaining the order relationship and a feature vector FB that is the latent variable not maintaining the order relationship are obtained.

Next, the decoder D01b will be described. The decoder D01b inputs the latent variable z1b (order-maintaining latent variable) and the feature vector FB, and outputs the output time-series data 402 having the same size as the input time-series data 401. That is, the decoder D01b inputs the order-maintaining latent variable and the feature vector FB, and outputs the output time-series data 402 conditioned with the feature vector FB.

The decoder D01b is realized by, for example, a neural network model ND1b that inputs a latent variable z1b and a feature vector FB and outputs output time-series data 402 that is a T-dimensional vector having the same dimension number as the input time-series data 401. The configuration of the neural network model ND1b can be similar to that of the neural network model ND1.

The learning unit 113 trains the encoder and the decoder together such that feature vectors corresponding to the average and variance obtained by the encoders (encoder E01b, condition generation unit E02b) approach the prior distribution and the difference (error) between the decoded output time-series data 402 and the input time-series data 401 decreases. As in FIG. 4, the learning unit 113 may execute learning using the importance degrees.

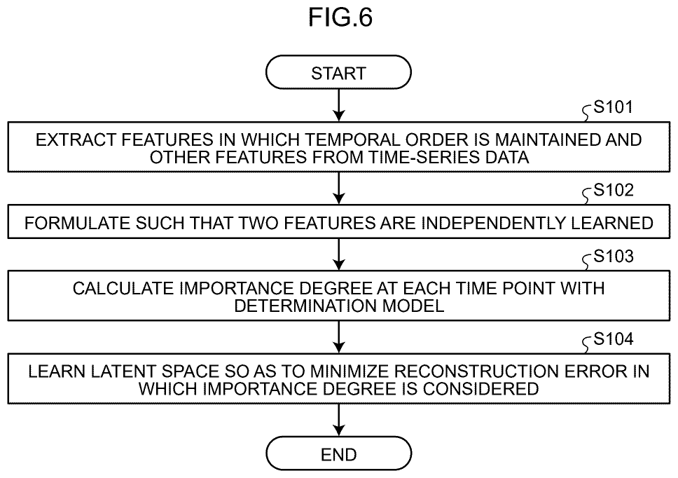

Next, a flow of process (learning process) of the learning phase by the information processing apparatus 100 according to the embodiment will be described. FIG. 6 is a flowchart illustrating an example of the learning process according to the embodiment.

The self-encoding unit 111 extracts a feature (feature vector FA) and other features (feature vector FB) maintaining the temporal order from the input time-series data using the encoder (Step S101). The learning unit 113 performs formulation such that the two feature vectors FA and FB are independently learned (Step S102). When the importance degrees are used, the calculation unit 112 calculates the importance degree of the input time-series data at each time point with the determination model (Step S103). The learning unit 113 learns the latent space (encoder, decoder) so as to minimize the reconstruction error in consideration of the importance degrees (Step S104).

The trained encoder and decoder are obtained by the learning process. The obtained information indicating the encoder and the decoder is stored in, for example, the storage unit 131 and used in the process of the generation phase by the generation unit 120.

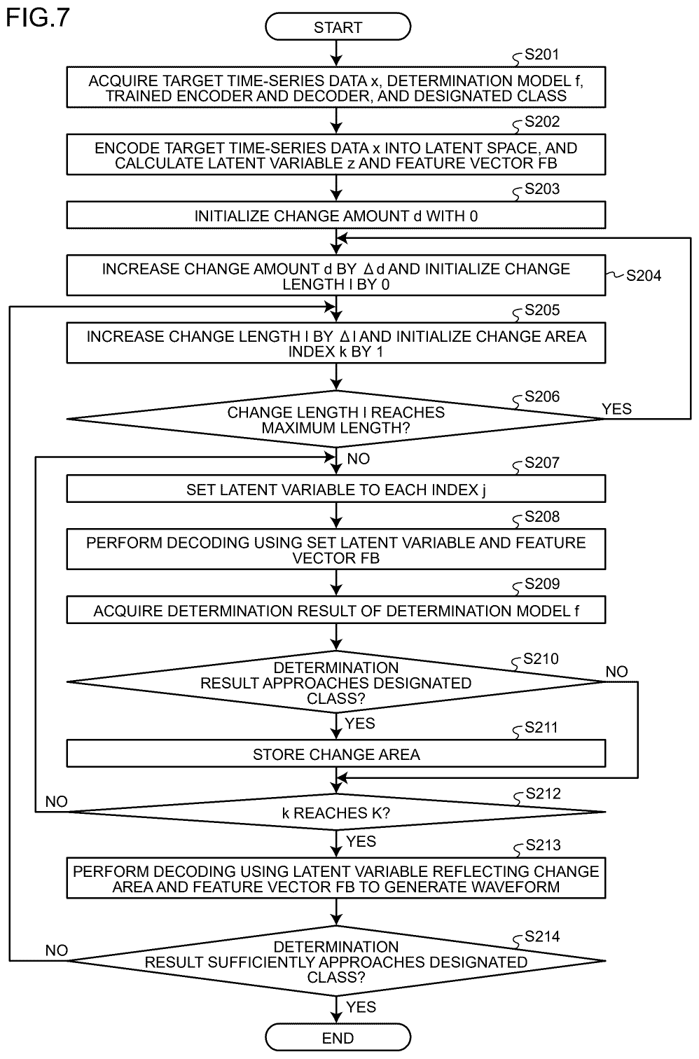

Next, a flow of process (generating process) of the generation phase by the information processing apparatus 100 according to the embodiment will be described. FIG. 7 is a flowchart illustrating an example of the generating process according to the embodiment.

In the related technique for generating an anti-fact waveform on the premise of a differentiable determination model, it is possible to generate an anti-fact waveform without searching for a change area by using differentiation of the determination model. On the other hand, in a case where a non-differentiable determination model is also included in the target, it is not possible to use differentiation, and thus, for example, a process of searching for a change area is required. Since the searching process may increase the processing time, it is desirable to more efficiently execute the generating process of the anti-fact waveform.

In the generating process of the present embodiment, the elements of the adjacent latent variables are collectively changed using the fact that the order-maintaining latent variables learned in the learning phase are arranged in temporal order, and the output time-series data is generated using the changed latent variables. As a result, it is possible to more efficiently generate the anti-fact waveform in which the change area is local.

First, the acquisition unit 101 acquires target time-series data x, a determination model f, the encoder and the decoder trained in the learning phase, and the designated class (Step S201). The acquisition unit 101 may acquire the number K of change areas (selected partial features) in the order-maintaining latent variable of the anti-fact waveform and the maximum length. In a case where the values of the number K and the maximum length are not acquired, predetermined values (default values) may be used as the number K and the maximum length. For example, a default value of the number K may be set to 1. As a default value of the maximum length, a length corresponding to 20% of the dimension of the latent space may be set.

The encoding unit 121 inputs the target time-series data x to the encoder, and calculates an m-dimensional order-maintaining latent variable z (feature vector FA) in which the temporal order is maintained and a feature vector FB in which the temporal order is not maintained (Step S202). The encoding unit 121 stores the feature vector FB that does not maintain the temporal order together with the order-maintaining latent variable z in the storage unit 131, for example, since the feature vector FB is necessary for decoding.

The generation unit 120 initializes a change amount d of the order-maintaining latent variable z to 0 (Step S203). d is a real value of 0 or more. The change amount d may be used both to increase and decrease the value of the element of the order-maintaining latent variable z.

Each subsequent step is a process (searching process) that is repeated until an appropriate anti-fact waveform is generated. The fact that the anti-fact waveform is appropriate means that, for example, the anti-fact waveform is determined as the designated class by the determination model f.

The generation unit 120 increases the change amount d of the order-maintaining latent variable z by Δd and initializes a change length l to 0 (Step S204). When the change amount d increases, it is more likely to be determined as the designated class, but it deviates from the input time-series data on the latent space. Δd is an amount for increasing the change amount d, and is, for example, a fixed value such as 0.01. Δd may be dynamically changed.

The change length l corresponds to the length of the change area having a value to be changed among the areas included in the order-maintaining latent variable z. The change length l may be represented by the number of elements of the order-maintaining latent variable z. In this case, the change area corresponding to two or more change lengths l corresponds to a partial feature including two or more adjacent elements. Since the order-maintaining latent variable z maintains the temporal order, if the change length l is short, the locality is also maintained in the change area for the target time-series data x of the anti-fact waveform obtained by decoding.

The generation unit 120 increases the change length l by Δl and initializes the index k (k is an integer satisfying 1≤k≤K,) of the change area to 1 (Step S205). Δl is an amount for increasing the change length l, and is, for example, a fixed value such as 1.

The generation unit 120 determines whether or not the change length l has reached the maximum length (Step S206). When the change length l has reached the maximum length (Step S206: Yes), the process returns to Step S204, and the process is repeated. That is, the change length l is initialized to 0, and the process is repeated by the change amount d increased by Δd.

In a case where the change length l has not reached the maximum length (Step S206: No), the process proceeds to Step S207 and subsequent steps. In Steps S207 to S212, the k-th change area is searched.

First, the generation unit 120 sets two latent variables zₖ⁺ and zₖ⁻ as follows for each index j (Step S207). The index j can be interpreted as corresponding to the start position of the change area (partial feature). That is, the generation unit 120 prepares the following two m-dimensional vectors for each index j=1, 2, . . . , and m−l+1 while changing the index j in the direction from the head to the tail of the m-dimensional vector of the order-maintaining latent variable z.

$${z}_{k}^{+} = ( {z}_{1} , {z}_{2} , … , {z}_{j} + d , {z}_{j + 1} + d , … , {z}_{j + 1 - 1} + d , {z}_{j + 1} , {z}_{j + 1 + 1} , … , {z}_{m} )$$

$${z}_{k}^{-} = ( {z}_{1} , {z}_{2} , … , {z}_{j} - d , {z}_{j + 1} - d , … , {z}_{j + 1 - 1} - d , {z}_{j + 1} , {z}_{j + 1 + 1} , … , {z}_{m} )$$

zₖ⁺ corresponds to a latent variable in which adjacent change areas of the length l starting from the index j of the order-maintaining latent variable z are collectively changed by +d. zₖ⁻ corresponds to a latent variable in which the same change area is collectively changed by −d.

Defining the change area of the length l from the index j can be interpreted as corresponding to the function of selecting the change area (partial feature) by the selection unit 122. In addition, changing the value of the element of the change area by +d or −d can be interpreted as corresponding to the function of generating a changed feature vector (latent variable zₖ⁺, zₖ⁻) changed from the feature vector FA by the change unit 123.

Next, the decoding unit 124 executes decoding by using the feature vector FB and each of the set latent variables zₖ⁺ and zₖ⁻, and obtains a T-dimensional vector corresponding to the output time-series data (Step S208). The decoding unit 124 obtains two T-dimensional vectors respectively corresponding to the two latent variables zₖ⁺ and zₖ⁻.

The determination unit 125 inputs each of the two T-dimensional vectors to the determination model f and acquires a determination result (output class) of the determination model f (Step S209). The determination unit 125 determines whether or not the acquired determination result approaches the designated class (Step S210).

For example, for the time series classification, the determination unit 125 determines that the determination result approaches the designated class in a case where the prediction probability of the designated class output from the determination model f increases. With respect to the abnormality detection, the determination unit 125 determines that the determination result approaches the designated class when the increase or decrease in the normality score or the abnormality score output from the determination model f occurs in the designated direction.

When the determination result approaches the designated class (Step S210: Yes), the determination unit 125 determines that the change with the changed feature vector (latent variable zₖ⁺ or zₖ⁻) is appropriate, and stores the corresponding change area (Step S211). The format of the change area to be stored may be any format, and may be, for example, a format of an m-dimensional vector in which a changed value (including positive and negative signs) is set for an element having a value changed. For example, in a case where the change with the latent variable zₖ⁺ is an appropriate change, an m-dimensional vector (0, 0, . . . , +d, +d, . . . , +d, 0, 0, . . . ) in which l elements from the index j are +d and other elements are 0 is the change area. In a case where the change with the latent variable zₖ⁻ is an appropriate change, an m-dimensional vector (0, 0, . . . , −d, −d, . . . , −d, 0, 0, . . . ) in which l elements from the index j are −d and other elements are 0 is the change area.

After the change area is stored, or when it is determined that the determination result does not approach the designated class (Step S210: No), the generation unit 120 determines whether or not the index k has reached the number K (Step S212).

In a case where the number of indexes k has not reached the number K (Step S212: No), the generation unit 120 returns to Step S207 and repeats the process for the next index (k obtained by adding 1). In the case of k=2, 3, . . . , and K, the index j is changed under the condition that the index j does not overlap the region corresponding to the element having a value that is not 0 in the m-dimensional vector storing the change area.

In a case where the number of indexes k reaches the number K (Step S212: Yes), the decoding unit 124 executes decoding by using the latent variable reflecting the change area and the feature vector FB, and generates an anti-fact waveform c (Step S213). The latent variable reflecting the change area is obtained, for example, by adding an m-dimensional vector storing K change areas to the order-maintaining latent variable z for each element.

The determination unit 125 inputs the anti-fact waveform c to the determination model f and determines whether or not the determination result by the determination model f sufficiently approaches the designated class (Step S214). For example, in a case where the determination result indicates the designated class (for example, in a case where the prediction probability of the designated class is the highest), the determination unit 125 determines that the determination result sufficiently approaches the designated class.

In a case where the determination result does not sufficiently approach the designated class (Step S214: No), the generation unit 120 returns to Step S205, adds Δl to the change length l, initializes the index k, and repeats the process. Note that the m-dimensional vector storing the change area is also initialized to a zero vector.

When the determination result sufficiently approaches the designated class (Step S214: Yes), the generation unit 120 ends the generating process. The anti-fact waveform c at this time is the final generation result.

As described above, in the information processing apparatus according to the embodiment, a latent space is learned based on a feature that maintains an order relationship of time of time-series data, and generates an anti-fact waveform in which the time-series data is locally changed by using the order relationship of time maintained in the latent space. This makes it possible to generate the data indicating the anti-fact explanation with higher accuracy.

In the present embodiment, since a differentiable determination model is not assumed, it is possible to generate an anti-fact waveform even if, for example, the determination model is an unclear (black box) model whether or not the determination model is differentiable. In addition, if the importance degree of each time of the time-series data is taken into consideration, it is possible to generate the anti-fact waveform according to the magnitude of the variation.

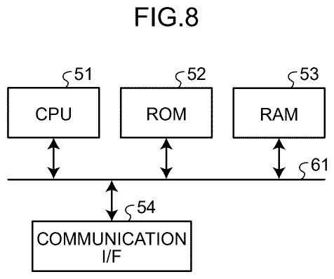

Next, a hardware configuration of the information processing apparatus according to the embodiment will be described with reference to FIG. 8. FIG. 8 is an explanatory diagram illustrating a hardware configuration example of the information processing apparatus according to the embodiment.

The information processing apparatus according to the embodiment includes a control device such as a central processing unit (CPU) 51, a storage device such as a read only memory (ROM) 52 and a random access memory (RAM) 53, a communication I/F 54 that is connected to a network and performs communication, and a bus 61 that connects the respective units.

The program executed by the information processing apparatus according to the embodiment is provided by being incorporated in the ROM 52 or the like in advance.

The program executed by the information processing apparatus according to the embodiment may be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Furthermore, the program executed by the information processing apparatus according to the embodiment may be stored on a computer connected to a network such as the Internet and provided by being downloaded via the network. Furthermore, the program executed by the information processing apparatus according to the embodiment may be provided or distributed via a network such as the Internet.

The program executed by the information processing apparatus according to the embodiment can cause a computer to function as each unit of the information processing apparatus described above. In this computer, the CPU 51 can read a program from a computer-readable storage medium onto a main storage device and execute the program.

Configuration Examples of the embodiment will be described below.

### (Configuration Example 1)

An information processing apparatus comprising
one or more hardware processors configured to:
   obtain a first feature including a feature indicating a temporal order and a second feature different from the first feature of input time-series data by using an encoder that extracts the first feature and the second feature from the input time-series data;
   obtain output time-series data generated based on the first feature and the second feature obtained from the input time-series data by using a decoder that generates the output time-series data based on the first feature and the second feature that are input; and
   train the encoder and the decoder such that a difference between the input time-series data and the output time-series data becomes small.

### (Configuration Example 2)

The information processing apparatus according to Configuration Example 1, wherein
the one or more hardware processors are configured to:
   calculate importance degrees of the input time-series data at a plurality of times, and
   train the encoder and the decoder such that the difference obtained by weighting values at the plurality of times with the importance degrees becomes small.

### (Configuration Example 3)

The information processing apparatus according to Configuration Example 2, wherein
the one or more hardware processors are configured to input the input time-series data to a determination model that determines a class to which the time-series data belongs, and calculate the importance degrees indicating degrees of change in determination results of the input time-series data that has been input at the plurality of times with the determination model.

### (Configuration Example 4)

The information processing apparatus according to any one of Configuration Examples 1 to 3, wherein
the encoder includes:
   a first neural network model to which the input time-series data is input, and that outputs a first vector having a dimension number smaller than a dimension number of the input time-series data and including a feature indicating a temporal order of the input time-series data; and
   a second neural network model to which the input time-series data is input, and that outputs a second vector having a dimension number smaller than the dimension number of the input time-series data, and
the encoder:
   obtains the first feature that is a first latent variable based on the first vector; and
   obtains the second feature that is a second latent variable based on the second vector.

### (Configuration Example 5)

The information processing apparatus according to Configuration Example 4, wherein
the first neural network model includes one or more convolution layers and one or more local pooling layers.

### (Configuration Example 6)

The information processing apparatus according to Configuration Example 4, wherein
the second neural network model includes one or more fully connected layers.

### (Configuration Example 7)

The information processing apparatus according to any one of Configuration Examples 1 to 3, wherein
the encoder includes:
   a second neural network model to which the input time-series data is input, and that outputs a second vector having a dimension number smaller than a dimension number of the input time-series data; and
   a first neural network model to which the second vector and the input time-series data are input, and that outputs a first vector having a dimension number smaller than the dimension number of the input time-series data and including a feature indicating a temporal order of the input time-series data, and
the encoder:
   obtains the first feature that is a first latent variable based on the first vector; and
   obtains the second feature that is the second vector.

### (Configuration Example 8)

The information processing apparatus according to Configuration Example 7, wherein
the first neural network model includes one or more convolution layers and one or more local pooling layers.

### (Configuration Example 9)

The information processing apparatus according to Configuration Example 7, wherein
the second neural network model includes one or more fully connected layers.

### (Configuration Example 10)

The information processing apparatus according to any one of Configuration Examples 1 to 9, wherein
the encoder obtains the second feature by frequency analysis on the input time-series data.

### (Configuration Example 11)

The information processing apparatus according to any one of Configuration Examples 1 to 10, wherein
the one or more hardware processors are configured to:
   obtain the first feature and the second feature by inputting target time-series data to be determined to the encoder;
   select, from the first feature, one or more partial features including elements having a consecutive temporal order, change a value of the selected partial feature to generate a changed feature changed from the first feature, input the changed feature and the second feature to the decoder to obtain the output time-series data, and repeatedly execute a searching process of obtaining an output class output by a determination model that determines a class to which the output time-series data belongs until the output class becomes a designated class; and
   output the output time-series data when the output class becomes the designated class.

### (Configuration Example 12)

An information processing apparatus comprising:
one or more hardware processors configured to:
   obtain a first feature including a feature indicating a temporal order and a second feature different from the first feature by inputting target time-series data to be determined to an encoder among the encoder that extracts the first feature and the second feature from input time-series data, and a decoder that generates output time-series data based on the first feature and the second feature that are input;
   select, from the first feature, one or more partial features including elements having a consecutive temporal order, change a value of the selected partial feature to generate a changed feature changed from the first feature, input the changed feature and the second feature to the decoder to obtain the output time-series data, and repeatedly execute a searching process of obtaining an output class output by a determination model that determines a class to which the output time-series data belongs until the output class becomes a designated class; and
output the output time-series data when the output class becomes the designated class.

### (Configuration Example 13)

The information processing apparatus according to Configuration Example 12, wherein
the one or more hardware processors are configured to:
   acquire a number of partial features to be selected and a maximum length representing a maximum value of lengths of the partial features to be selected; and
   select, from the first feature, the number of partial features having a length shorter than the maximum length.

### (Configuration Example 14)

The information processing apparatus according to Configuration Example 13, wherein
two adjacent elements among a plurality of elements included in the first feature are elements closer to each other in temporal order than other elements, and
the one or more hardware processors are configured to select the partial feature including two or more adjacent elements.

### (Configuration Example 15)

The information processing apparatus according to Configuration Example 13, wherein
the one or more hardware processors are configured to select the number of partial features having different start positions while changing a length without exceeding the maximum length, and repeatedly execute the searching process until the output class becomes the designated class.

### (Configuration Example 16)

The information processing apparatus according to any one of Configuration Examples 12 to 15, wherein
the determination model includes a non-differentiable model.

### (Configuration Example 17)

The information processing apparatus according to any one of Configuration Examples 12 to 16, wherein
the determination model is an abnormality detection model that determines which of a plurality of classes the input time-series data belongs to, the class including a normal class indicating that the time-series data is normal and an abnormal class indicating that the time-series data is abnormal, and
the input time-series data is time-series data that is regarded as belonging to the normal class.

### (Configuration Example 18)

The information processing apparatus according to Configuration Example 17, wherein
the abnormality detection model includes:
   a generation model that generates a waveform feature vector of the input time-series data, and
   a determination model that determines which of the plurality of classes the input time-series data belongs to using the waveform feature vector.

### (Configuration Example 19)

An information processing method executed by an information processing apparatus, the method comprising:
obtaining a first feature including a feature indicating a temporal order and a second feature different from the first feature of input time-series data by using an encoder that extracts the first feature and the second feature, from the input time-series data;
obtaining output time-series data generated based on the first feature and the second feature obtained from the input time-series data by using a decoder that generates the output time-series data based on the first feature and the second feature that are input; and
training the encoder and the decoder such that a difference between the input time-series data and the output time-series data becomes small.

### (Configuration Example 20)

An information processing method executed by an information processing apparatus, the method comprising:
obtaining a first feature including a feature indicating a temporal order and a second feature different from the first feature by inputting target time-series data to be determined to an encoder among the encoder that extracts the first feature and the second feature from input time-series data, and a decoder that generates output time-series data based on the first feature and the second feature that are input;
selecting, from the first feature, one or more partial features including elements having a consecutive temporal order, changing a value of the selected partial feature to generate a changed feature changed from the first feature, inputting the changed feature and the second feature to the decoder to obtain the output time-series data, and repeatedly executing a searching process of obtaining an output class output by a determination model that determines a class to which the output time-series data belongs until the output class becomes a designated class; and
outputting the output time-series data when the output class becomes the designated class.

### (Configuration Example 21)

A program causing a computer to execute:
obtaining a first feature including a feature indicating a temporal order and a second feature different from the first feature of input time-series data by using an encoder that extracts the first feature and the second feature, from input time-series data;
obtaining output time-series data generated based on the first feature and the second feature obtained from the input time-series data by using a decoder that generates the output time-series data based on the first feature and the second feature that are input; and
training the encoder and the decoder such that a difference between the input time-series data and the output time-series data becomes small.

### (Configuration Example 22)

22. A program causing a computer to execute:
obtaining a first feature including a feature indicating a temporal order and a second feature different from the first feature by inputting target time-series data to be determined to an encoder among an encoder that extracts the first feature and the second feature from input time-series data, and a decoder that generates output time-series data based on the first feature and the second feature being input;
selecting, from the first feature, one or more partial features including elements having a consecutive temporal order, changing a value of the selected partial feature to generate a changed feature changed from the first feature, inputting the changed feature and the second feature to the decoder to obtain the output time-series data, and repeatedly executing a searching process of obtaining an output class output by a determination model that determines a class to which the output time-series data belongs until the output class becomes a designated class; and
outputting the output time-series data when the output class becomes the designated class.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
one or more hardware processors configured to:
obtain a first feature including a feature indicating a temporal order and a second feature different from the first feature of input time-series data by using an encoder that extracts the first feature and the second feature from the input time-series data;
obtain output time-series data generated based on the first feature and the second feature obtained from the input time-series data by using a decoder that generates the output time-series data based on the first feature and the second feature that are input; and
train the encoder and the decoder such that a difference between the input time-series data and the output time-series data becomes small.

2. The apparatus according to claim 1, wherein
the one or more hardware processors are configured to:
calculate importance degrees of the input time-series data at a plurality of times, and
train the encoder and the decoder such that the difference obtained by weighting values at the plurality of times with the importance degrees becomes small.

3. The apparatus according to claim 2, wherein
the one or more hardware processors are configured to input the input time-series data to a determination model that determines a class to which the time-series data belongs, and calculate the importance degrees indicating degrees of change in determination results of the input time-series data that has been input at the plurality of times with the determination model.

4. The apparatus according to claim 1, wherein
the encoder includes:
a first neural network model to which the input time-series data is input, and that outputs a first vector having a dimension number smaller than a dimension number of the input time-series data and including a feature indicating a temporal order of the input time-series data; and
a second neural network model to which the input time-series data is input, and that outputs a second vector having a dimension number smaller than the dimension number of the input time-series data, and
the encoder:
obtains the first feature that is a first latent variable based on the first vector; and
obtains the second feature that is a second latent variable based on the second vector.

5. The apparatus according to claim 4, wherein
the first neural network model includes one or more convolution layers and one or more local pooling layers.

6. The apparatus according to claim 4, wherein
the second neural network model includes one or more fully connected layers.

7. The apparatus according to claim 1, wherein
the encoder includes:
a second neural network model to which the input time-series data is input, and that outputs a second vector having a dimension number smaller than a dimension number of the input time-series data; and
a first neural network model to which the second vector and the input time-series data are input, and that outputs a first vector having a dimension number smaller than the dimension number of the input time-series data and including a feature indicating a temporal order of the input time-series data, and
the encoder:
obtains the first feature that is a first latent variable based on the first vector; and
obtains the second feature that is the second vector.

8. The apparatus according to claim 7, wherein
the first neural network model includes one or more convolution layers and one or more local pooling layers.

9. The apparatus according to claim 7, wherein
the second neural network model includes one or more fully connected layers.

10. The apparatus according to claim 1, wherein
the encoder obtains the second feature by frequency analysis on the input time-series data.

11. The apparatus according to claim 1, wherein
the one or more hardware processors are configured to:
obtain the first feature and the second feature by inputting target time-series data to be determined to the encoder;
select, from the first feature, one or more partial features including elements having a consecutive temporal order, change a value of the selected partial feature to generate a changed feature changed from the first feature, input the changed feature and the second feature to the decoder to obtain the output time-series data, and repeatedly execute a searching process of obtaining an output class output by a determination model that determines a class to which the output time-series data belongs until the output class becomes a designated class; and
output the output time-series data when the output class becomes the designated class.

12. An information processing apparatus comprising:
one or more hardware processors configured to:
obtain a first feature including a feature indicating a temporal order and a second feature different from the first feature by inputting target time-series data to be determined to an encoder among the encoder that extracts the first feature and the second feature from input time-series data, and a decoder that generates output time-series data based on the first feature and the second feature that are input;
select, from the first feature, one or more partial features including elements having a consecutive temporal order, change a value of the selected partial feature to generate a changed feature changed from the first feature, input the changed feature and the second feature to the decoder to obtain the output time-series data, and repeatedly execute a searching process of obtaining an output class output by a determination model that determines a class to which the output time-series data belongs until the output class becomes a designated class; and
output the output time-series data when the output class becomes the designated class.

13. The apparatus according to claim 12, wherein
the one or more hardware processors are configured to:
acquire a number of partial features to be selected and a maximum length representing a maximum value of lengths of the partial features to be selected; and
select, from the first feature, the number of partial features having a length shorter than the maximum length.

14. The apparatus according to claim 13, wherein
two adjacent elements among a plurality of elements included in the first feature are elements closer to each other in temporal order than other elements, and
the one or more hardware processors are configured to select the partial feature including two or more adjacent elements.

15. The apparatus according to claim 13, wherein
the one or more hardware processors are configured to select the number of partial features having different start positions while changing a length without exceeding the maximum length, and repeatedly execute the searching process until the output class becomes the designated class.

16. The apparatus according to claim 12, wherein
the determination model includes a non-differentiable model.

17. The apparatus according to claim 12, wherein
the determination model is an abnormality detection model that determines which of a plurality of classes the input time-series data belongs to, the class including a normal class indicating that the time-series data is normal and an abnormal class indicating that the time-series data is abnormal, and
the input time-series data is time-series data that is regarded as belonging to the normal class.

18. The apparatus according to claim 17, wherein
the abnormality detection model includes:
a generation model that generates a waveform feature vector of the input time-series data, and
a determination model that determines which of the plurality of classes the input time-series data belongs to using the waveform feature vector.

19. An information processing method executed by an information processing apparatus, the method comprising:
obtaining a first feature including a feature indicating a temporal order and a second feature different from the first feature of input time-series data by using an encoder that extracts the first feature and the second feature, from the input time-series data;
obtaining output time-series data generated based on the first feature and the second feature obtained from the input time-series data by using a decoder that generates the output time-series data based on the first feature and the second feature that are input; and
training the encoder and the decoder such that a difference between the input time-series data and the output time-series data becomes small.

20. An information processing method executed by an information processing apparatus, the method comprising:
obtaining a first feature including a feature indicating a temporal order and a second feature different from the first feature by inputting target time-series data to be determined to an encoder among the encoder that extracts the first feature and the second feature from input time-series data, and a decoder that generates output time-series data based on the first feature and the second feature that are input;
selecting, from the first feature, one or more partial features including elements having a consecutive temporal order, changing a value of the selected partial feature to generate a changed feature changed from the first feature, inputting the changed feature and the second feature to the decoder to obtain the output time-series data, and repeatedly executing a searching process of obtaining an output class output by a determination model that determines a class to which the output time-series data belongs until the output class becomes a designated class; and
outputting the output time-series data when the output class becomes the designated class.

21. A computer program product comprising a non-transitory computer-readable medium including programmed instructions, the instructions causing a computer to execute:
obtaining a first feature including a feature indicating a temporal order and a second feature different from the first feature of input time-series data by using an encoder that extracts the first feature and the second feature, from input time-series data;
obtaining output time-series data generated based on the first feature and the second feature obtained from the input time-series data by using a decoder that generates the output time-series data based on the first feature and the second feature that are input; and
training the encoder and the decoder such that a difference between the input time-series data and the output time-series data becomes small.

22. A computer program product comprising a non-transitory computer-readable medium including programmed instructions, the instructions causing a computer to execute:
obtaining a first feature including a feature indicating a temporal order and a second feature different from the first feature by inputting target time-series data to be determined to an encoder among an encoder that extracts the first feature and the second feature from input time-series data, and a decoder that generates output time-series data based on the first feature and the second feature being input;
selecting, from the first feature, one or more partial features including elements having a consecutive temporal order, changing a value of the selected partial feature to generate a changed feature changed from the first feature, inputting the changed feature and the second feature to the decoder to obtain the output time-series data, and repeatedly executing a searching process of obtaining an output class output by a determination model that determines a class to which the output time-series data belongs until the output class becomes a designated class; and
outputting the output time-series data when the output class becomes the designated class.
